(19) United States
(12) Patent Application Publication
(10) Pub. No.: US 2018/0248188 A1
(43) Pub. Date: Aug. 30, 2018

(54) ELECTRODE FOR LITHIUM-ION SECONDARY BATTERY AND LITHIUM-ION SECONDARY BATTERY

(71) Applicant: SUMITOMO OSAKA CEMENT CO., LTD., Tokyo (JP)

(72) Inventors: Takao KITAGAWA, Funabashi-shi (JP); Hirofumi YASUMIISHI, Yachiyo-shi (JP)

(21) Appl. No.: 15/710,553

(22) Filed: Sep. 20, 2017

(30) Foreign Application Priority Data
Feb. 27, 2017 (JP) 2017-034805

(51) Int. Cl. H01M 4/58; H01M 4/525; H01M 4/505; H01M 10/0525

(52) U.S. Cl. CPC H01M 4/5825; H01M 4/525; C01B 25/30; H01M 10/0525; H01M 4/505

(57) ABSTRACT

An electrode for a lithium-ion secondary battery including an electrode mixture layer made of a mixture including a first electrode active material including a compound represented by General Formula LiₐA_{b}PO₄, a second electrode active material including at least one compound selected from the group consisting of compounds represented by Li_{c}B_{d}O₂, a lithium cobaltate-based compound, a lithium manganate-based compound, and a lithium nickelate-based compound, a conductive auxiliary agent, and a binder, in which a thermal conductivity of the electrode for the lithium-ion secondary battery, which is derived from Expression (1) using a thermal diffusivity, a constant pressure specific heat, and an electrode density of the electrode for a lithium-ion secondary battery, is 0.9 W/(m·K) or more.

### CROSS-REFERENCE TO RELATED APPLICATIONS

This application claims the benefit of Japanese Patent Application No. 2017-034805 filed Feb. 27, 2017, the disclosure of which is herein incorporated by reference in its entirety.

### BACKGROUND OF THE INVENTION

### Field of the Invention

The present invention relates to an electrode for a lithium-ion secondary battery and a lithium-ion secondary battery including the same.

### Description of Related Art

In recent years, as batteries anticipated to have a small size, a light weight, a high capacity, and a high output, non-aqueous electrolytic solution-based secondary batteries such as lithium-ion secondary batteries have been proposed and put into practical use.

These lithium-ion secondary batteries are constituted of a cathode and an anode which have properties capable of reversibly intercalating and deintercalating lithium ions and a non-aqueous electrolyte.

In recent years, studies have been underway to apply lithium-ion secondary batteries to storage batteries for electric power storage, automatic two-wheel vehicles, electric vehicles, plug-in hybrid vehicles, hybrid vehicles, idling stop systems, and the like. Accordingly, the research and development of lithium-ion secondary batteries expands toward an increase in the capacity and the energy density.

As anode active materials for anode materials of lithium-ion secondary batteries, generally, carbon-based materials or Li-containing metal oxides having properties capable of reversibly intercalating and deintercalating lithium ions such as lithium titanate (Li₄Ti₅O₁₂) are used.

As cathode active materials for cathode materials of lithium-ion secondary batteries, Li-containing metal oxides having properties capable of reversibly intercalating and deintercalating lithium ions such as lamellar oxide-based lithium cobaltate (LCO), ternary lamellar oxides (NCM) obtained by substituting some of cobalt with manganese and nickel, spinel lithium manganese oxide (LMO) which is a lithium manganate compound, and lithium iron phosphate (LFP), or electrode material mixtures including a binder are used. In addition, this electrode material mixture is applied onto the surface of a metal foil that is called a current collector, thereby forming cathodes for lithium-ion secondary batteries.

These lithium-ion secondary batteries have a smaller size and a higher energy and weigh less than secondary batteries in the related art such as lead batteries, nickel cadmium batteries, and nickel metal hydride batteries. Therefore, lithium-ion secondary batteries are used not only as small-size power supplies used in portable electronic devices such as mobile phones and notebook personal computers but also as large-size stationary emergency power supplies. In addition, in recent years, lithium-ion secondary batteries have also been studied as high-output power supplies for plug-in hybrid vehicles, hybrid vehicles, electric power tools, and the like. For lithium-ion secondary batteries that are used as the high-output power supplies, there is a demand for high-speed charging and discharging characteristics.

However, electrode active materials, for example, electrode materials including a lithium phosphate compound which has properties capable of reversibly intercalating and deintercalating lithium ions have a problem of a low electron conductivity. Therefore, in order to increase the electron conductivity of electrode materials, electrode materials obtained by covering the surfaces of the particles of an electrode active material with an organic component that is a carbon source, then, carbonizing the organic component so as to form a carbonaceous film on the surfaces of the particles of the electrode active material, and interposing carbon in the carbonaceous film as an electron-conducting substance are proposed (for example, refer to Japanese Laid-open Patent Publication No. 2001-15111).

In addition, the electron conductivity of electrode active materials is preferably high. When the thickness of the carbonaceous film formed on the surface of the electrode active material becomes uneven, places with a low electron conductivity are locally generated in the cathode. Therefore, in a case in which lithium-ion secondary batteries are used as large-size stationary emergency power supplies, particularly, at a low temperature, in the lithium-ion secondary batteries, a problem of a decrease in the capacity caused by voltage drop at the final stage of discharging is caused. Therefore, in the related art, for the purpose of decreasing the unevenness in the thickness of the carbonaceous film in the electrode active material, a method in which the unevenness in the thickness of carbonaceous films in electrode active materials is alleviated by controlling the agglomerate density of agglomerated particles has been proposed (for example, refer to Japanese Laid-open Patent Publication No. 2012-13388).

### SUMMARY OF THE INVENTION

However, due to an increase in the capacity and energy density of lithium-ion secondary batteries, when lithium-ion secondary batteries are charged and discharged, particularly, at high rates, there are cases in which the emission of heat caused by the redox reaction of cathode materials locally increases the temperatures in electrodes. As a result, deterioration of electrode materials such as the dissolution of metallic elements from cathode materials is accelerated.

The present invention has been made in consideration of the above-described circumstances, and an object of the present invention is to provide an electrode for a lithium-ion secondary battery which includes an electrode mixture layer made of a mixture including an electrode active material, a conductive auxiliary agent, and a binder and is capable of rapidly solving the local increase in the temperature of the electrode for a lithium-ion secondary battery in which the density of the electrode mixture layer is 2.0 g/cm³ or more and a lithium-ion secondary battery including the electrode.

The present inventors and the like carried out intensive studies in order to achieve the above-described object, consequently found that, during the manufacturing of an electrode for a lithium-ion secondary battery, when the electrode includes a first electrode active material and a second electrode active material, and a thermal conductivity of the electrode for a lithium-ion secondary battery is set to 0.9 W/(m·K) or more, it is possible to improve the heat dissipation characteristics of the electrode for a lithium-ion secondary battery and rapidly solve the local increase in the temperature of the electrode for a lithium-ion secondary battery caused by the emission of heat caused by the redox reaction of a cathode material when the lithium-ion secondary battery having an increased capacity and an increased energy density is charged and discharged, particularly, at high rates, and completed the present invention.

An electrode for a lithium-ion secondary battery of the present invention is an electrode for a lithium-ion secondary battery including an electrode mixture layer made of a mixture, the mixture including a first electrode active material including a compound represented by General Formula LiₐA_{b}PO₄ (here, A represents at least one element selected from the group consisting of Fe, Mn, Co, and Ni, 0≤a≤1.0, and 0<b≤1.0), a second electrode active material including at least one compound selected from the group consisting of compounds represented by General Formula Li_{c}B_{d}O₂ (here, B represents at least one element selected from the group consisting of Fe, Mn, Co, and Ni, 0≤c≤1.0, and 0<d≤1.0), a lithium cobaltate-based compound, a lithium manganate-based compound, and a lithium nickelate-based compound, a conductive auxiliary agent, and a binder, in which a thermal conductivity of the electrode for the lithium-ion secondary battery, which is derived from Expression (1) using a thermal diffusivity, a constant pressure specific heat, and an electrode density of the electrode for a lithium-ion secondary battery, is 0.9 W/(m·K) or more,

λ=α×Cp×ρ×100 (1)

wherein in the Expression 1, λ is the thermal conductivity [W/(m·K)], α is the thermal diffusivity [cm²/sec], Cp is the constant pressure specific heat [J/(g·K)], and ρ is the electrode density [g/cm³].

A lithium-ion secondary battery of the present invention includes the electrode for the lithium-ion secondary battery of the present invention.

According to the electrode for a lithium-ion secondary battery of the present invention, when the lithium-ion secondary battery is charged and discharged at high rates, the local increase in the temperature of the first electrode active material or the second electrode active material caused by the emission of heat caused by the redox reaction of the cathode material supplies heat generated by the redox reaction to adjacent electrode active materials having no relationship with the redox reaction due to their different discharge potentials, and consequently, it becomes possible to rapidly solve the local increase in the temperature of the electrode for a lithium-ion secondary battery.

According to the lithium-ion secondary battery of the present invention, the lithium-ion secondary battery includes the electrode for a lithium-ion secondary battery of the present invention, and thus high-speed charging and discharging becomes possible.

### DETAILED DESCRIPTION OF THE INVENTION

Embodiments of an electrode for a lithium-ion secondary battery of the present invention and a lithium-ion secondary battery including the same will be described.

Meanwhile, the present embodiment is specific description for better understanding of the gist of the invention and does not limit the present invention unless particularly otherwise described.

Electrode for Lithium-Ion Secondary Battery

An electrode for a lithium-ion secondary battery of the present embodiment includes an electrode mixture layer made of a mixture (electrode material mixture) including a first electrode active material, a second electrode active material, a conductive auxiliary agent, and a binder. That is, the electrode for a lithium-ion secondary battery of the present embodiment includes an electrode current collector and the electrode mixture layer formed on the electrode current collector, and the electrode mixture layer is made of a mixture including a first electrode active material, a second electrode active material, a conductive auxiliary agent, and a binder. In the present embodiment, materials including the first electrode active material and the second electrode active material are electrode materials for lithium-ion secondary batteries.

In addition, in the electrode for a lithium-ion secondary battery of the present embodiment, the thermal conductivity of the electrode for a lithium-ion secondary battery, which is derived from Expression (1) using the thermal diffusivity, the specific heat, and the electrode density of the electrode for a lithium-ion secondary battery of the present embodiment, is 0.9 W/(m·K) or more.

λ=α×Cp×ρ×100 (1)
λ: thermal conductivity [W/(m·K)]
α: thermal diffusivity [cm²/sec]
Cp: constant pressure specific heat [J/(g·K)]
ρ: electrode density [g/cm³]

When the thermal conductivity of the electrode for a lithium-ion secondary battery is less than 0.9 W/(m·K), the temperature of the electrode for a lithium-ion secondary battery locally increases. As a result, it becomes impossible to charge and discharge lithium-ion secondary batteries including the electrode for a lithium-ion secondary battery at high rates.

Electrode Material for Lithium-Ion Secondary Battery

The first electrode active material in the present embodiment includes a compound represented by General Formula LiₐA_{b}PO₄ (here, A represents at least one element selected from the group consisting of Fe, Mn, Co, and Ni, 0≤a≤1.0, and 0<b≤1.0).

In addition, the first electrode active material preferably includes the compound represented by General Formula LiₐA_{b}PO₄ (here, A represents at least one element selected from the group consisting of Fe, Mn, Co, and Ni, 0≤a≤1.0, and 0<b≤1.0) and a compound represented by General Formula LiₑC_{f}PO₄ (here, C represents at least one element selected from the group consisting of Fe and Mn, 0≤e<2, and 0<f<1.5) which is present on the surface of the compound represented by General Formula LiₐA_{b}PO₄.

Examples of the compound represented by General Formula LiₐA_{b}PO₄ (hereinafter, also referred to as “compound A”) include LiFePO₄, LiMnPO₄, LiCoPO₄, LiNiPO₄, LiFe_{0.5}Mn_{0.5}PO₄, LiFe_{0.4}Mn_{0.6}PO₄, LiFe_{0.3}Mn_{0.7}PO₄, LiFe_{0.2}Mn_{0.8}PO₄, LiFe_{0.1}Mn_{0.9}PO₄, and the like.

Examples of the compound represented by General Formula LiₑC_{f}PO₄ (hereinafter, also referred to as “compound B”) include LiFePO₄, Li₂FePO₄, LiMnPO₄, Li₂MnPO₄, LiFe_{0.5}Mn_{0.5}PO₄, LiFe_{0.4}Mn_{0.6}PO₄, LiFe_{0.3}Mn_{0.7}PO₄, LiFe_{0.2}Mn_{0.8}PO₄, LiFe_{0.1}Mn_{0.9}PO₄, Li₂Fe_{0.5}Mn_{0.5}PO₄, Li₂Fe_{0.4}Mn_{0.6}PO₄, Li₂Fe_{0.3}Mn_{0.7}PO₄, Li₂Fe_{0.2}Mn_{0.8}PO₄, Li₂Fe_{0.1}Mn_{0.9}PO₄, and the like.

The first electrode active material includes the compound A and the compound B present on the surface of the compound A and thus, even in, for example, materials in which the compound A is not capable of easily forming a carbonaceous film on the surface of the electrode active material such as LiMnPO₄, LiCoPO₄, or LiNiPO₄, enables the formation of a carbonaceous film on the surface of the electrode active material due to the compound B interposed therein.

In a case in which the first electrode active material includes the compound A and the compound B present on the surface of the compound A, the molar ratio between the compound A and the compound B is preferably 99.9:0.1 to 90.0:10.0 and more preferably 99.5:0.5 to 95.0:5.0.

In addition, the first electrode active material forms an agglomerate formed by the agglomeration of first electrode active material particles having a carbonaceous film formed on the surface. The volume density of the agglomerate is 50% by volume or more and 80% by volume or less of the volume density obtained in a case in which the agglomerate is assumed to be solid.

Here, the solid agglomerate refers to an agglomerate having no pores, and the density of the solid agglomerate is considered to be equal to the theoretical density of the first electrode active material.

In addition, the agglomerate formed by the agglomeration of the first electrode active material particles having a carbonaceous film formed on the surface refer to an agglomerate in which the first electrode active material particles having a carbonaceous film on the surface agglomerate together in a point-contact state and the contact portions between the first electrode active material particles form neck shapes having a small cross-sectional area and are thus strongly connected to each other. When the contact portions between the first electrode active material particles form neck shapes having a small cross-sectional area as described above, the agglomerate has a structure in which channel-shaped (network-shaped) pores expand in three dimensions.

Meanwhile, when the volume density of the agglomerate is 50% by volume or more of the volume density obtained in a case in which the agglomerate is assumed to be solid, the agglomerate becomes dense, and thus the strength of the agglomerate increases, and the agglomerate does not easily break, for example, when an electrode slurry is prepared by mixing the first electrode active material with a binder, a conductive auxiliary agent, and a solvent. As a result, an increase in the viscosity of the electrode slurry is suppressed, and the fluidity is maintained. Therefore, the coatability of the electrode slurry improves, and it is also possible to improve the filling property of the first electrode active material in coatings made of the electrode slurry. In a case in which the agglomerate breaks during the preparation of the electrode slurry, the amount of the binder necessary to bind the first electrode active material particles increases, and thus an increase in the viscosity of the electrode slurry increases, a decrease in the concentration of the solid contents in the electrode slurry decreases, and a decrease in the ratio of the first electrode active material to the mass of cathode films are caused, which is not preferable.

The particle diameters of the primary particles of the first electrode active material are not particularly limited, but the average particle diameter is preferably 0.01 μm or more and 20 μm or less and more preferably 0.02 μm or more and 5 μm or less.

Here, the reasons for limiting the average particle diameter of the primary particles of the first electrode active material in the above-described range are as described below. When the average particle diameter of the primary particles is 0.01 μm or more, it is possible to sufficiently coat the surfaces of the primary particles with a thin carbon film, and thus the discharge capacity of lithium-ion secondary batteries at a high charge-discharge rate increases, and sufficient charge and discharge rate performance can be realized. On the other hand, when the average particle diameter of the primary particles is 20 μm or less, the internal resistance of the primary particles does not increase, and thus the discharge capacity of lithium-ion secondary batteries at a high charge-discharge rate improves.

In a case in which the first electrode active material is used as an electrode material for lithium-ion secondary batteries, in order to uniformly cause a reaction regarding the intercalation and deintercalation of lithium ions throughout the entire surface of the first electrode active material, at least 80% or more of the surface of the compound A constituting the first electrode active material is preferably coated with a carbonaceous film, and at least 90% or more of the surface of the compound A constituting the first electrode active material is more preferably coated with a carbonaceous film. In a case in which the first electrode active material includes the compound A and the compound B present on the surface of the compound A, there are cases in which the surface of the compound A and the surface of the compound B are coated with a carbonaceous film.

In this case, the density of the electrode mixture layer made of the mixture including the first electrode active material, a second electrode active material, a conductive auxiliary agent, and a binder is preferably 2.0 g/cm³ or more, and more preferably 2.1 g/cm³ or more. When the density of the electrode mixture layer is 2.0 g/cm³ or more, it also becomes possible to apply the electrode for a lithium-ion secondary battery of the present embodiment to usage requiring a high energy density such as storage batteries for electric power storage, automatic two-wheel vehicles, electric vehicles, plug-in hybrid vehicles, hybrid vehicles, idling stop systems, and the like.

The coating ratio of the carbonaceous film on the surface of the first electrode active material can be measured using a transmission electron microscope (TEM), an energy-dispersive X-ray spectrometer (EDX), or the like. The coating ratio of the carbonaceous film on the surface of the first electrode active material is 60% or more and preferably 80% or more. Here, when the coating ratio of the carbonaceous film on the surface of the first electrode active material is less than 60%, the coating effect of the carbonaceous film becomes insufficient. As a result, when the intercalation and deintercalation reaction of lithium ions is caused on the surface of the first electrode active material, the reaction resistance regarding the intercalation and deintercalation of lithium ions increases in places in which the carbonaceous film is not formed.

The amount of carbon in the carbonaceous film is preferably 0.6% by mass or more and 2.0% by mass or less and more preferably 1.1% by mass or more and 1.7% by mass or less of the mass percentage (in a case in which the total amount of the carbonaceous film is set to 100% by mass) of the first electrode active material.

Here, the reasons for limiting the amount of carbon in the carbonaceous film in the above-described range are as described below. When the amount of carbon is 0.6% by mass or more, the coating ratio of the carbonaceous film in the first electrode active material becomes 60% or more, and thus the discharge capacity at a high charge-discharge rate increases in a case in which lithium-ion secondary batteries are formed. As a result, lithium-ion secondary batteries become capable of realizing sufficient charge and discharge rate performance. On the other hand, when the amount of carbon is less than 2.0% by mass, the lithium ion migration resistance caused by steric hindrance does not increase during the diffusion of lithium ions in the carbonaceous film. As a result, the internal resistance of lithium-ion secondary batteries does not increase, and voltage does not drop at a high charge-discharge rate of lithium-ion secondary batteries.

In addition, the average value of the thicknesses in the carbonaceous film in the first electrode active material is preferably 1.0 nm or more and 7.0 nm or less and more preferably 3.0 nm or more and 5.0 nm or less.

Here, the reasons for limiting the average value of the thicknesses in the carbonaceous film in the above-described range are as described below. When the average value of the thicknesses of the carbonaceous film is 1.0 nm or more, the charge migration resistance in the carbonaceous film does not increase. As a result, the internal resistance of lithium-ion secondary batteries does not increase, and voltage does not drop at a high charge-discharge rate of lithium-ion secondary batteries. On the other hand, when the average value of the thicknesses in the carbonaceous film is 7.0 nm or less, the lithium ion migration resistance caused by steric hindrance does not increase during the diffusion of lithium ions in the carbonaceous film. As a result, the internal resistance of lithium-ion secondary batteries does not increase, and voltage does not drop at a high charge-discharge rate of lithium-ion secondary batteries.

The specific surface area of the first electrode active material is preferably 5 m²/g or more and 20 m²/g or less and more preferably 9 m²/g or more and 13 m²/g or less.

Here, the reasons for limiting the specific surface area of the first electrode active material in the above-described range are as described below. When the specific surface area is 5 m²/g or more, the average value of the thicknesses in the carbonaceous film does not exceed 7.0 nm in a case in which the amount of carbon in the carbonaceous film is 2.0% by mass. On the other hand, when the specific surface area is 20 m²/g or less, the amount of carbon in the carbonaceous film reaches 0.6% by mass or more, and the average value of the thicknesses in the carbonaceous film reaches 1.0 nm or more.

The density of the carbonaceous film, which is computed using the carbon component in the carbonaceous film, is preferably 0.3 g/cm³ or more and 1.5 g/cm³ or less and more preferably 0.4 g/cm³ or more and 1.0 g/cm³ or less.

Here, the reasons for limiting the density of the carbonaceous film, which is computed using the carbon component in the carbonaceous film, in the above-described range are as follows. When the density of the carbonaceous film, which is computed using the carbon component in the carbonaceous film, is 0.3 g/cm³ or more, the carbonaceous film exhibits a sufficient electron conductivity. On the other hand, when the density of the carbonaceous film is 1.5 g/cm³ or less, the amount of fine graphite crystals made of a lamellar structure in the carbonaceous film is small, and thus steric hindrance caused by fine graphite crystals is not caused during the diffusion of lithium ions in the carbonaceous film. Therefore, the lithium ion migration resistance does not increase. As a result, the internal resistance of lithium-ion secondary batteries does not increase, and voltage does not drop at a high charge-discharge rate of lithium-ion secondary batteries.

The mass of the carbon component constituting the carbonaceous film is preferably 50% by mass or more and more preferably 60% by mass or more of the total mass of the carbonaceous film.

The reason for limiting the proportion of the mass of the carbon component constituting the carbonaceous film in the total mass of the carbonaceous film in the above-described range is as described below. The carbonaceous film is generated by the thermal decomposition of an organic compound that is a precursor of carbon, and the carbonaceous film includes other elements other than carbon such as hydrogen and oxygen. When the calcination temperature is 500° C. or lower, the portion of the mass of the carbon component in the mass of the carbonaceous film reaches less than 50% by mass, and the charge migration resistance of the carbonaceous film increases. As a result, the internal resistance of lithium-ion secondary batteries increases, and voltage drop at a high charge-discharge rate becomes significant.

The second electrode active material in the present embodiment includes at least one compound selected from the group consisting of compounds represented by General Formula Li_{c}B_{d}O₂ (here, B represents at least one element selected from the group consisting of Fe, Mn, Co, and Ni, 0≤c≤1.0, and 0<d≤1.0), lithium cobaltate-based compounds, lithium manganate-based compounds, and lithium nickelate-based compounds.

Examples of the compounds represented by General Formula Li_{c}B_{d}O₂ (hereinafter, also referred to as “compound C”) include LiNi_{1/3}Co_{1/3}Mn_{1/3}O₂, LiNi_{0.8}Co_{0.15}Al_{0.05}O₂, and the like.

The average particle diameter of the secondary particles of the first electrode active material is preferably 0.01 M or more and 0.30 M or less and more preferably 0.05 M or more and 0.25 M or less of the average particle diameter (M) of the secondary particles of the second electrode active material.

Here, the reason for limiting the average particle diameter of the secondary particles of the first electrode active material in the above-described range is as described below. The secondary particles of the first electrode active material enter voids formed by the secondary particles of the second electrode active material, and thus the improvement of the electrode density is accelerated, and voids among the secondary particles of the first electrode active material are filled with the first electrode active material, and thus the thermal conductivity of the electrode for a lithium-ion secondary battery improves compared with a single body of the second electrode active material.

The average particle diameter (M) of the secondary particles of the second electrode active material is preferably 10 μm or more and 200 μm or less, more preferably 15 μm or more and 150 μm or less, and still more preferably 20 μm or more and 100 μm or less.

Here, the reasons for limiting the average particle diameter (M) of the secondary particles of the second electrode active material in the above-described range are as described below. When the average particle diameter (M) of the secondary particles of the second electrode active material is 10 μm or more, it is not necessary to set the lower limit value of the average particle diameter of the secondary particles of the first electrode active material to less than 0.1 μm. Meanwhile, it is difficult to set the lower limit value of the average particle diameter of the secondary particles of the first electrode active material to less than 0.1 μm. On the other hand, when the average particle diameter (M) of the secondary particles of the second electrode active material is 200 μm or less, the upper limit value of the average particle diameter of the secondary particles of the first electrode active material reaches 44 μm or less, and thus voids formed among the secondary particles of the first electrode active material do not become too large. Therefore, it is possible to sufficiently obtain an effect of the joint use of the first electrode active material and the second electrode active material that improve the electrode density.

Method for Manufacturing Electrode Material for Lithium-Ion Secondary Battery

The method for manufacturing an electrode material for a lithium-ion secondary battery in the present embodiment is not particularly limited, and examples thereof include a method in which the first electrode active material and the second electrode active material which are manufactured using a method described below are mixed together.

The method for manufacturing the first electrode active material in the present embodiment is a method in which a slurry including the compound A or a precursor of the compound A and an organic compound and having a ratio (D90/D10) of D90 to D10 in the particle size distribution of the compound A or the precursor of the compound A of 5 or more and 30 or less is dried and then the obtained dried substance is calcinated in a non-oxidative atmosphere at 500° C. or higher and 1,000° C. or lower.

Here, D90 refers to the particle diameter at a cumulative volume percentage of 90% in the particle size distribution, and D10 refers to the particle diameter at a cumulative volume percentage of 10% in the particle size distribution.

Similar to the compound A described in the description of the electrode material, the compound A is a compound represented by General Formula LiₐA_{b}PO₄ (here, A represents at least one element selected from the group consisting of Fe, Mn, Co, and Ni, 0≤a≤1.0, and 0<b≤1.0).

As the compound A represented by General Formula LiₐA_{b}PO₄ (LiₐA_{b}PO₄ powder), compounds manufactured using a method of the related art such as a solid-phase method, a liquid-phase method, and a gas-phase method can be used.

As the compound A (LiₐA_{b}PO₄ powder), it is possible to preferably use, for example, a compound (LiₐA_{b}PO₄ powder) obtained by hydrothermally synthesizing a slurry-form mixture obtained by mixing a Li source selected from lithium salts such as lithium acetate (LiCH₃COO) and lithium chloride (LiCl) or lithium hydroxide (LiOH), a divalent iron salt such as iron (II) chloride (FeCl₂), iron (II) acetate (Fe(CH₃COO)₂), or iron (II) sulfate (FeSO₄), a phosphoric acid compound such as phosphoric acid (H₃PO₄), ammonium dihydrogen phosphate (NH₄H₂PO₄), or diammonium hydrogen phosphate ((NH₄)₂HPO₄), and water using a pressure-resistant airtight container, cleaning the obtained precipitate with water so as to generate a cake-form electrode active material or precursor substance of an electrode active material, and calcinating the cake-form electrode active material or precursor substance of the electrode active material.

The LiₐA_{b}PO₄ powder may be crystalline particles or amorphous particles and may be mixed crystal particles in which crystalline particles and amorphous particles coexist. Here, the reason that the LiₐA_{b}PO₄ powder may be amorphous particles is that, when thermally treated in a non-oxidative atmosphere at 500° C. or higher and 1,000° C. or lower, the amorphous LiₐA_{b}PO₄ powder is crystallized.

In addition, in a case in which the first electrode active material includes the compound A and the compound B present on the surface of the compound A, the method for manufacturing the first electrode active material in the present embodiment is a method in which a slurry including the compound A or a precursor of the compound A, the compound B or a precursor of the compound B, and an organic compound, having a ratio (D90/D10) of D90 to D10 in the particle size distribution of the compound A or the precursor of the compound A of 5 or more and 30 or less, and having a ratio (D90/D10) of D90 to D10 in the particle size distribution of the compound B or the precursor of the compound B of 7 or more and 25 or less is dried and then the obtained dried substance is calcinated in a non-oxidative atmosphere at 500° C. or higher and 1,000° C. or lower.

Similar to the compound B described in the description of the electrode material, the compound B is a compound represented by General Formula LiₑC_{f}PO₄ (here, C represents at least one element selected from the group consisting of Fe and Mn, 0≤e<2, and 0<f<1.5).

As the compound B represented by General Formula LiₑC_{f}PO₄ (LiₑC_{f}PO₄ powder), compounds manufactured using a method of the related art such as a solid-phase method, a liquid-phase method, and a gas-phase method can be used.

As the compound B (LiₑC_{f}PO₄ powder), it is possible to preferably use, for example, a compound (LiₑC_{f}PO₄ powder) that is formed on the surface of the compound A when complex powder obtained by dissolving a slurry-form mixture obtained by mixing a Li source selected from lithium salts such as lithium acetate (LiCH₃COO) and lithiumchloride (LiCl) or lithiumhydroxide (LiOH), a divalent iron salt such as iron (II) chloride (FeCl₂), iron (II) acetate (Fe(CH₃COO)₂), or iron (II) sulfate (FeSO₄), a phosphoric acid compound such as phosphoric acid (H₃PO₄), ammonium dihydrogen phosphate (NH₄H₂PO₄), or diammonium hydrogen phosphate ((NH₄)₂HPO₄), and water through the adjustment of the pH, mixing the obtained aqueous solution with the cake-form precursor substance of the compound A, and drying the mixture is calcinated.

The LiₑC_{f}PO₄ powder may be crystalline particles or amorphous particles and may be mixed crystal particles in which crystalline particles and amorphous particles coexist. Here, the reason that the LiₑC_{f}PO₄ powder may be amorphous particles is that, when thermally treated in a non-oxidative atmosphere at 500° C. or higher and 1,000° C. or lower, the amorphous LiₑC_{f}PO₄ powder is crystallized.

The method for manufacturing the second electrode active material in the present embodiment is a method in which a slurry including the compound C or a precursor of the compound C and having a ratio (D90/D10) of D90 to D10 in the particle size distribution of the compound C or the precursor of the compound C of 5 or more and 30 or less is dried and then the obtained dried substance is calcinated in a non-oxidative atmosphere at 500° C. or higher and 1,000° C. or lower.

Similar to the compound C described in the description of the electrode material, the compound C is a compound represented by General Formula Li_{c}B_{d}O₂ (here, B represents at least one element selected from the group consisting of Fe, Mn, Co, and Ni, 0≤c≤1.0, and 0<d≤1.0).

As the compound A represented by General Formula Li_{c}B_{d}O₂ (Li_{c}B_{d}O₂ powder), compounds manufactured using a method of the related art such as a solid-phase method, a liquid-phase method, and a gas-phase method can be used.

As the compound C (Li_{c}B_{d}O₂ powder), it is possible to preferably use, for example, a compound (Li_{c}B_{d}O₂ powder) obtained by drying a slurry-form mixture obtained by mixing a Li source selected from lithium salts such as lithium acetate (LiCH₃COO) and lithium chloride (LiCl) or lithium hydroxide (LiOH), a divalent nickel salt such as nickel (II) chloride (NiCl₂), nickel (II) oxide (NiO), nickel (II) acetate (Ni(CH₃COO)₂), or nickel (II) sulfate (NiSO₄), a divalent cobalt salt such as cobalt (II) chloride (CoCl₂), cobalt (II) oxide (CoO), cobalt (II) acetate (Co(CH₃COO)₂), or cobalt (II) sulfate (CoSO₄), a divalent manganese salt such as manganese (II) chloride (MnCl₂), manganese (II) oxide (MnO), manganese (II) acetate (Mn(CH₃COO)₂), or manganese (II) sulfate (MnSO₄), and water, solid-phase-calcinating the mixture by means of calcination in the atmosphere, cleaning the obtained precipitate with water so as to generate a cake-form precursor substance, and calcinating the cake-form precursor substance.

The Li_{c}B_{d}O₂ powder may be crystalline particles or amorphous particles and may be mixed crystal particles in which crystalline particles and amorphous particles coexist. Here, the reason that the Li_{c}B_{d}O₂ powder may be amorphous particles is that, when thermally treated in a non-oxidative atmosphere at 500° C. or higher and 1,000° C. or lower, the amorphous Li_{c}B_{d}O₂ powder is crystallized.

The shapes of the first electrode active material and the second electrode active material manufactured as described above are not particularly limited, but are preferably spherical, particularly, truly spherical. When the shapes of the first electrode active material and the second electrode active material are truly spherical, the first electrode active material and the second electrode active material easily form electrode materials made of the secondary particles thereof.

Here, the reasons that the shapes of the first electrode active material and the second electrode active material are preferably spherical are that the amount of the solvent in the preparation of the electrode material mixture by mixing the first electrode active material, the second electrode active material, a binder resin (binding agent), and the solvent and the application of the electrode material mixture to the electrode current collector also becomes easy.

In addition, when the shapes of the first electrode active material and the second electrode active material are preferably spherical, the specific surfaces of the first electrode active material and the second electrode active material are minimized, and it is possible to minimize the blending amount of the binder resin (binding agent) added to the electrode material mixture. As a result, it is possible to decrease the internal resistance of electrodes to be obtained.

Furthermore, when the shapes of the first electrode active material and the second electrode active material are preferably spherical, it becomes easy to closely pack the first electrode active material and the second electrode active material during the application of the electrode material mixture onto the electrode current collector, and thus the amount of the electrode material packed per unit volume increases. Therefore, it is possible to increase the electrode density, and consequently, the capacity of lithium-ion secondary batteries can be increased.

Examples of the organic compound that are used to manufacturing the first electrode active material include polyvinyl alcohol, polyvinyl pyrrolidone, cellulose, starch, gelatin, carboxymethyl cellulose, methyl cellulose, hydroxymethyl cellulose, hydroxyethyl cellulose, polyacrylic acid, polystyrene sulfonate, polyacrylamide, polyvinyl acetate, glucose, fructose, galactose, mannose, maltose, sucrose, lactose, glycogen, pectin, alginic acid, glucomannan, chitin, hyaluronic acid, chondroitin, agarose, polyethers, polyvalent alcohols, and the like.

In a case in which the first electrode active material only includes the compound A except for the carbonaceous film, regarding the blending ratio between the compound A and the organic compound, when converted to the amount of carbon, the total amount of the organic component is preferably 0.6 parts by mass or more and 2.0 parts by mass or less and more preferably 1.1 parts by mass or more and 1.7 parts by mass or less with respect to 100 parts by mass of the compound A. In addition, in a case in which the first electrode active material only includes the compound A and the compound B except for the carbonaceous film, regarding the blending ratio among the compound A, the compound B, and the organic compound, when converted to the amount of carbon, the total amount of the organic component is preferably 0.6 parts by mass or more and 2.0 parts by mass or less and more preferably 1.1 parts by mass or more and 1.7 parts by mass or less with respect to 100 parts by mass of the total amount of the compound A and the compound B.

When the blending ratio converted to the amount of carbon in the organic compound is 0.6 parts by mass or more, the coating ratio of the carbonaceous film in the first electrode active material is above 60%, and thus, in a case in which lithium-ion secondary batteries are formed, the discharge capacity at a high charge-discharge rate increases. As a result, it is possible to realize the sufficient charge and discharge rate performance of lithium-ion secondary batteries. On the other hand, when the blending ratio converted to the amount of carbon in the organic compound is 2.0 parts by mass or less, the average value of the thicknesses in the carbonaceous film in the first electrode active material reaches less than 7 nm, and the lithium ion migration resistance caused by steric hindrance does not increase during the diffusion of lithium ions in the carbonaceous film. As a result, the internal resistance of lithium-ion secondary batteries does not increase, and voltage does not drop at a high charge-discharge rate of lithium-ion secondary batteries.

The compound A or the compound A and the compound B and the organic compound are dissolved or dispersed in water, thereby preparing a homogeneous slurry. In the dissolution or dispersion of the compound A or the compound A and the compound B and the organic compound in water, a dispersant is preferably added.

The method for dissolving or dispersing the compound A or the compound A and the compound B and the organic compound in water is not particularly limited as long as the compound A or the compound A and the compound B are dispersed and the organic compound is dissolved or dispersed, and examples thereof include methods in which a medium stirring-type dispersion device that stirs medium particles at a high rate such as a planetary ball mill, an oscillation ball mill, a bead mill, a paint shaker, or an attritor is preferably used.

During the dissolution or dispersion, it is preferable to disperse the compound A or the compound A and the compound B in water in a primary particle form and then stir the components so as to dissolve or disperse the organic compound in the water including the compound A or the compound A and the compound B. In such a case, the surfaces of the primary particles of the compound A or the primary particles of the compound A and the compound B are coated with the organic compound, and consequently, carbon derived from the organic compound is uniformly interposed among the primary particles of the compound A or the primary particles of the compound A and the compound B.

In addition, it is preferable to appropriately adjust the dispersion conditions of the slurry, for example, the concentrations of the compound A or the compound A and the compound B, the concentrations of the organic compound, the stirring time, and the like so that the ratio (D90/D10) in the particle size distributions of the precursors of the compound A or the compound A and the compound B in the slurry reaches 5 or more and 30 or less.

Next, the slurry is sprayed and dried in a high-temperature atmosphere, for example, in the atmosphere of 70° C. or higher and 250° C. or lower.

Next, the dried substance is calcinated in a non-oxidative atmosphere at a temperature of preferably 500° C. or higher and 1,000° C. or lower and more preferably 600° C. or higher and 900° C. or lower. In addition, the dried substance is preferably calcinated for 0.1 hours or longer and 40 hours or shorter in this temperature range.

Here, the reasons for limiting the calcination temperature to 500° C. or higher and 1,000° C. or lower are as described below. When the calcination temperature is 500° C. or higher, the decomposition and reaction of the organic compound in the dried substance sufficiently proceed, and the organic compound is sufficiently carbonized. As a result, high-resistance decomposed substances of the organic compound are not generated in the obtained agglomerate. Meanwhile, when the calcination temperature is 1,000° C. or lower, Li in the compound A or the compound A and the compound B are not evaporated, and thus the composition of the first electrode active material does not deviate, the particle growth in the first electrode active material is not accelerated, and consequently, the discharge capacity at a high charge-discharge rate increases, and it is possible to realize sufficient charge and discharge rate performance of lithium-ion secondary batteries.

The non-oxidative atmosphere is preferably an inert atmosphere such as nitrogen (N₂) or argon (Ar) or a reducing atmosphere including a reducing gas such as hydrogen (H₂). In a case in which it is necessary to further suppress the oxidation, a reducing atmosphere is preferred. In addition, for the purpose of removing organic components evaporated in the non-oxidative atmosphere during the calcination, a susceptible or burnable gas such as oxygen (O₂) may be introduced into the inert atmosphere.

Here, the particle size distribution in the agglomerate to be obtained can be controlled by appropriately adjusting the drying conditions of the slurry, for example, the concentration of the slurry, the amount of liquid and gas, the shape of nozzles, the drying temperature, and the like.

Here, the particle size distribution of the primary particles in the agglomerate to be obtained can be controlled by appropriately adjusting the calcination conditions of the dried substance, for example, the temperature-increase rate, the peak holding temperature, the holding time, and the like.

Through the above-described processes, the surfaces of the primary particles of the compound A or the compound A and the compound B are coated with carbon generated by the thermal decomposition of the organic compound in the dried substance, thereby obtaining the first electrode active material made of secondary particles in which carbon is interposed among the primary particles of the electrode active material.

Conductive Auxiliary Agent

The conductive auxiliary agent is not particularly limited, and, for example, at least one element selected from the group consisting of particulate carbon such as acetylene black, ketjen black, and furnace black and fibrous carbon such as vapor-grown carbon fiber (VGCF) and carbon nanotube is used.

The content rate of the conductive auxiliary agent in the electrode material mixture is preferably 2% by mass or more and 10% by mass or less and more preferably 4% by mass or more and 8% by mass or less in a case in which the total mass of the electrode material for a lithium-ion secondary battery, the binder, and the conductive auxiliary agent in the present embodiment is set to 100% by mass.

Here, the reasons for limiting the content rate of the conductive auxiliary agent in the above-described range are as described below. When the content rate of the conductive auxiliary agent is 2% by mass or more, in a case in which the electrode mixture layer is formed using the electrode material mixture including the electrode material for a lithium-ion secondary battery in the present embodiment, the electron conductivity becomes sufficient, and the battery capacity or the charge and discharge rate improves. On the other hand, when the content rate of the conductive auxiliary agent is 10% by mass or less, the portion of the electrode material in the electrode mixture layer relatively increases, and the battery capacity of lithium-ion secondary batteries per unit volume improves.

Binder

The binder is not particularly limited, and examples thereof include at least one binder selected from the group of polyvinylidene fluoride, polyethylene, polypropylene, polyethylene terephthalate, polymethyl methacrylate, vinyl acetate copolymers, styrene/butadiene-based latex, acrylic latex, acrylonitrile/butadiene-based latex, fluorine-based latex, silicon-based latex, and the like.

The content rate of the binder in the electrode material mixture is preferably 2% by mass or more and 10% by mass or less and more preferably 4% by mass or more and 8% by mass or less in a case in which the total mass of the electrode material for a lithium-ion secondary battery, the binder, and the conductive auxiliary agent in the present embodiment is set to 100% by mass.

Here, the reasons for limiting the content rate of the binder in the above-described range are as described below. When the content rate of the binder is 2% by mass or more, in a case in which the electrode mixture layer is formed using the electrode material mixture including the electrode material for a lithium-ion secondary battery in the present embodiment, the binding property between the electrode mixture layer and the electrode current collector becomes sufficient, and the electrode mixture layer does not fracture or drop during the formation of the electrode mixture layer by means of rolling or the like. In addition, the electrode mixture layer does not peel from the electrode current collector in the charging and discharging process of batteries, and the battery capacity or the charge and discharge rate does not decrease. On the other hand, when the content of the binding agent is 10% by mass or less, the internal resistance of the electrode material for a lithium-ion secondary battery does not increase, and the battery capacity of lithium-ion secondary batteries at a high charge-discharge rate does not decrease.

Method for Manufacturing Electrode for Lithium-Ion Secondary Battery

In order to manufacture the electrode for a lithium-ion secondary battery of the present embodiment, the electrode material for a lithium-ion secondary battery of the present embodiment, the binder, the conductive auxiliary agent, and the solvent are mixed together so as to prepare the electrode material mixture, the electrode material mixture is applied onto one main surface of the electrode current collector so as to forma coated film, and the coated film is dried and then pressed. Therefore, it is possible to obtain the electrode for a lithium-ion secondary battery in which the electrode mixture layer is formed on one main surface of the electrode current collector.

The method for mixing the electrode material for a lithium-ion secondary battery of the present embodiment, the binder, the conductive auxiliary agent, and the solvent is not particularly limited as long as these components can be uniformly mixed together, and examples thereof include methods in which a kneader such as a ball mill, a sand mill, a planetary (sun-and-planet) mixer, a paint shaker, or a homogenizer is used.

As the solvent, an organic solvent such as N-methyl-2-pyrrolidone (NMP) or water is used, but water-based solvents such as alcohols, glycols, and ethers may be included in water as long as the characteristics of the electrode material for a lithium-ion secondary battery in the present embodiment are maintained.

According to the electrode for a lithium-ion secondary battery of the present embodiment, when the lithium-ion secondary battery is charged and discharged at high rates, the local increase in the temperature of the first electrode active material or the second electrode active material caused by the emission of heat caused by the redox reaction of the cathode material supplies heat generated by the redox reaction to adjacent electrode active materials having no relationship with the redox reaction due to their different discharge potentials, and consequently, it becomes possible to rapidly solve the local increase in the temperature of the electrode for a lithium-ion secondary battery.

Lithium-Ion Secondary Battery

The lithium-ion secondary battery of the present embodiment includes the electrode for a lithium-ion secondary battery of the present embodiment as the cathode and is formed by including the cathode, an anode, a separator, and an electrolytic solution.

In the lithium-ion secondary battery of the present embodiment, the anode, the electrolytic solution, the separator, and the like are not particularly limited.

As the anode, for example, it is possible to use anode materials such as Li metal, carbon materials, Li alloys, Li₄Ti₅O₁₂, and the like.

In addition, instead of the electrolytic solution and the separator, a solid electrolyte may be used.

The electrolytic solution can be produced by, for example, mixing ethylene carbonate (EC) and ethyl methyl carbonate (EMC) so that the volume ratio therebetween reaches 1:1 and dissolving lithium hexafluorophosphate (LiPF₆) in the obtained solvent mixture so that the concentration reaches 1 mol/dm³.

As the separator, it is possible to use, for example, porous propylene.

According to the lithium-ion secondary battery of the present embodiment, the electrode for a lithium-ion secondary battery of the present embodiment is included as the cathode, and thus high-speed charging and discharging becomes possible.

### EXAMPLES

Hereinafter, the present invention will be more specifically described using examples and comparative examples, but the present invention is not limited to the following examples.

For example, in the present example, metal Li was used as the anode in order to reflect the behaviors of electrode materials in data, but anode materials such as carbon materials, Li alloys, and Li₄Ti₅O₁₂ may also be used. In addition, instead of an electrolytic solution and a separator, a solid electrolyte may be used.

### Example 1

Production of Electrode Material

Lithiumhydroxide (LiOH) (6 mol), iron (II) sulfate (FeSO₄) (2 mol), and phosphoric acid (H₃PO₄) (2 mol) were mixed with water (2 L) so that the total amount reached 4 L, thereby preparing a homogeneous slurry-form mixture.

Next, this mixture was stored in a pressure-resistant airtight container having a capacity of 8 L and was hydrothermally synthesized at 150° C. for one hour.

Next, the obtained precipitate was cleaned with water, thereby obtaining a cake-form electrode active material.

Next, a lactose aqueous solution obtained by dissolving the electrode active material (150 g in terms of the solid content) and lactose (6 g) as an organic compound in water (200 g) and zirconia balls (500 g) having a diameter of 0.1 mm as medium particles were injected into a ball mill, the rotation speed of the ball mill and the stirring time were adjusted so that D90/D10 in the particle size distribution of electrode active material particles in the slurry reached 20, and a dispersion treatment was carried out.

Next, the obtained slurry was sprayed in the atmosphere at 180° C. and dried, thereby obtaining a dried substance having an average particle diameter of 25 μm.

Next, the obtained dried substance was calcinated in a nitrogen atmosphere for one hour at 790° C., thereby obtaining a LiFePO₄ agglomerate having an average secondary particle diameter of 25 μm. This agglomerate was used as the first electrode active material.

In addition, as a second electrode active material, lithium nickel cobalt manganese oxide (LiNi_{1/3}Co_{1/3}Mn_{1/3}O₂) having an average secondary particle diameter of 100 μm was used.

A mixture obtained by mixing the first electrode active material and the second electrode active material so that the mass ratios between the first electrode active material and the second electrode active material reached 10%:90% was used as an electrode material.

Production of Electrode

The electrode material, polyvinylidene fluoride (PVdF) as a binder, and acetylene black (AB) as a conductive auxiliary agent were mixed together so that the mass ratio reached 90:5:5, and furthermore, N-methyl-2-pyrrolidinone (NMP) was added as a solvent so as to impart fluidity, thereby preparing a slurry.

Next, this slurry was applied and dried on a 15 μm-thick aluminum (Al) foil.

After that, the aluminum foil was pressurized at a pressure of 600 kgf/cm², thereby producing an electrode for a lithium-ion secondary battery of Example 1.

Evaluation of Electrode

The thermal diffusivity, constant pressure specific heat, and electrode density of the electrode were respectively measured using a cyclic heating method, a DSC method, and an archimedes method, and the thermal conductivity was computed from Expression (1). The thermal diffusivity, the constant pressure specific heat, the electrode density, and the electrode thermal conductivity are shown in Table 1.

λ=α×Cp×ρ×100 (1)
λ: thermal conductivity [W/(m·K)]
α: thermal diffusivity [cm²/sec]
Cp: constant pressure specific heat [J/(g·K)]
ρ: electrode density [g/cm³]

Production of Lithium-Ion Secondary Battery

A natural graphite anode was disposed as an opposite electrode so as to face the electrode for a lithium-ion secondary battery, and a separator made of porous polypropylene was disposed between the electrode for a lithium-ion secondary battery and the opposite electrode, thereby producing a member for a battery.

Meanwhile, ethylene carbonate and diethyl carbonate were mixed together in a mass ratio of 1:1, and furthermore, 1 mol/L of LiPF₆ was added thereto, thereby preparing an electrolyte solution having lithium ion conductivity.

Next, the member for a battery was immersed in the electrolyte solution, thereby producing a lithium-ion secondary battery of Example 1.

Evaluation of Lithium-Ion Secondary Battery

The cycle characteristics of the lithium-ion secondary battery were evaluated. The method for evaluating the cyclic characteristics is as described below.

As a charging and discharging test of the lithium-ion secondary battery, a cycle of one-hour charging and then one-hour discharging with a constant current at a cut-off voltage of 2 V to 4.5 V and a charge-discharge rate of 1 C was carried out 500 times at 45° C. In addition, the value of the discharge amount after the 500 cycles expressed as percentage when the initial discharge amount was considered as 100 was specified as “the capacity retention after 500 cycles at 45° C.”.

Meanwhile, the initial charging of the lithium-ion secondary battery was carried out with a constant current (1 C) and a constant voltage (4.5 V, the charging was ended when the current value reached approximately 0.01 C), and the discharge amount at the second charging, which was obtained by subtracting the amount of lithium ions consumed to form the solid electrolyte interface (SEI) of the anode during the initial charging, was specified as the initial discharge amount. The results are shown in Table 1.

### Example 2

An electrode material and an electrode for a lithium-ion secondary battery of Example 2 were produced in the same manner as in Example 1 except for the fact that a mixture obtained by mixing the first electrode active material and the second electrode active material so that the mass ratio between the first electrode active material and the second electrode active material reached 20% and 80% was used as the electrode material.

In addition, the obtained electrode was evaluated in the same manner as in Example 1. The results are shown in Table 1.

Furthermore, the lithium-ion secondary battery of Example 2 was produced in the same manner as in Example 1 using the obtained electrode.

The obtained lithium-ion secondary battery was evaluated in the same manner as in Example 1. The results are shown in Table 1.

### Example 3

An electrode material and an electrode for a lithium-ion secondary battery of Example 3 were produced in the same manner as in Example 1 except for the fact that a mixture obtained by mixing the first electrode active material and the second electrode active material so that the mass ratio between the first electrode active material and the second electrode active material reached 30% and 70% was used as the electrode material.

In addition, the obtained electrode was evaluated in the same manner as in Example 1. The results are shown in Table 1.

Furthermore, the lithium-ion secondary battery of Example 3 was produced in the same manner as in Example 1 using the obtained electrode.

The obtained lithium-ion secondary battery was evaluated in the same manner as in Example 1. The results are shown in Table 1.

### Example 4

An electrode material and an electrode for a lithium-ion secondary battery of Example 4 were produced in the same manner as in Example 1 except for the fact that a mixture obtained by mixing the first electrode active material and the second electrode active material so that the mass ratio between the first electrode active material and the second electrode active material reached 40% and 60% was used as the electrode material.

In addition, the obtained electrode was evaluated in the same manner as in Example 1. The results are shown in Table 1.

Furthermore, the lithium-ion secondary battery of Example 4 was produced in the same manner as in Example 1 using the obtained electrode.

The obtained lithium-ion secondary battery was evaluated in the same manner as in Example 1. The results are shown in Table 1.

### Example 5

An electrode material and an electrode for a lithium-ion secondary battery of Example 5 were produced in the same manner as in Example 1 except for the fact that a mixture obtained by mixing the first electrode active material and the second electrode active material so that the mass ratio between the first electrode active material and the second electrode active material reached 50% and 50% was used as the electrode material.

In addition, the obtained electrode was evaluated in the same manner as in Example 1. The results are shown in Table 1.

Furthermore, the lithium-ion secondary battery of Example 5 was produced in the same manner as in Example 1 using the obtained electrode.

The obtained lithium-ion secondary battery was evaluated in the same manner as in Example 1. The results are shown in Table 1.

### Example 6

An electrode material and an electrode for a lithium-ion secondary battery of Example 6 were produced in the same manner as in Example 1 except for the fact that lithium manganate (LiMn₂O₄) having an average secondary particle diameter of 157 μm was used as the second electrode active material and a mixture obtained by mixing the first electrode active material and the second electrode active material so that the mass ratio between the first electrode active material and the second electrode active material reached 50% and 50% was used as the electrode material.

In addition, the obtained electrode was evaluated in the same manner as in Example 1. The results are shown in Table 1.

Furthermore, the lithium-ion secondary battery of Example 6 was produced in the same manner as in Example 1 using the obtained electrode.

The obtained lithium-ion secondary battery was evaluated in the same manner as in Example 1. The results are shown in Table 1.

### Example 7

An electrode material and an electrode for a lithium-ion secondary battery of Example 7 were produced in the same manner as in Example 1 except for the fact that lithium nickel cobalt aluminum oxide (LiNi_{0.8}Co_{0.15}Al_{0.05}O₂) having an average secondary particle diameter of 56 μm was used as the second electrode active material and a mixture obtained by mixing the first electrode active material and the second electrode active material so that the mass ratio between the first electrode active material and the second electrode active material reached 50% and 50% was used as the electrode material.

In addition, the obtained electrode was evaluated in the same manner as in Example 1. The results are shown in Table 1.

Furthermore, the lithium-ion secondary battery of Example 7 was produced in the same manner as in Example 1 using the obtained electrode.

The obtained lithium-ion secondary battery was evaluated in the same manner as in Example 1. The results are shown in Table 1.

### Example 8

Production of Electrode Material

Lithiumhydroxide (LiOH) (6 mol), iron (II) sulfate (FeSO₄) (0.6 mol), manganese sulfate (MnSO₄) (1.4 mol), and phosphoric acid (H₃PO₄) (2 mol) were mixed with water (2 L) so that the total amount reached 4 L, thereby preparing a homogeneous slurry-form mixture.

Next, this mixture was stored in a pressure-resistant airtight container having a capacity of 8 L and was hydrothermally synthesized at 170° C. for one hour.

Next, the obtained precipitate was cleaned with water, thereby obtaining a cake-form electrode active material.

Next, a lactose aqueous solution obtained by dissolving the electrode active material (150 g in terms of the solid content) and lactose (6 g) as an organic compound in water (200 g) and zirconia balls (500 g) having a diameter of 0.1 mm as medium particles were injected into a ball mill, the rotation speed of the ball mill and the stirring time were adjusted so that D90/D10 in the particle size distribution of electrode active material particles in the slurry reached 40, and a dispersion treatment was carried out.

Next, the obtained slurry was sprayed in the atmosphere at 180° C. and dried, thereby obtaining a dried substance having an average particle diameter of 5 μm.

Next, the obtained dried substance was calcinated in a nitrogen atmosphere for one hour at 790° C., thereby obtaining a LiFe_{0.3}Mn_{0.7}O₄ agglomerate having an average secondary particle diameter of 5 μm. This agglomerate was used as the first electrode active material.

In addition, as a second electrode active material, lithium nickel cobalt manganese oxide (LiNi_{1/3}Co_{1/3}Mn_{1/3}O₂) having an average secondary particle diameter of 100 μm was used.

A mixture obtained by mixing the first electrode active material and the second electrode active material so that the mass ratios between the first electrode active material and the second electrode active material reached 10%:90% was used as an electrode material.

Production of Electrode

The electrode material, polyvinylidene fluoride (PVdF) as a binder, and acetylene black (AB) as a conductive auxiliary agent were mixed together so that the mass ratio reached 90:5:5, and furthermore, N-methyl-2-pyrrolidinone (NMP) was added as a solvent so as to impart fluidity, thereby preparing a slurry.

Next, this slurry was applied and dried on a 15 μm-thick aluminum (Al) foil.

After that, the aluminum foil was pressurized at a pressure of 600 kgf/cm², thereby producing an electrode for a lithium-ion secondary battery of Example 8.

Evaluation of Electrode

The electrode thermal conductivity of the electrode was computed in the same manner as in Example 1. The thermal diffusivity, constant pressure specific heat, electrode density, and electrode thermal conductivity are shown in Table 1.

Production of Lithium-Ion Secondary Battery

A lithium-ion secondary battery of Example 8 was produced in the same manner as in Example 1 using the electrode for a lithium-ion secondary battery.

Evaluation of Lithium-Ion Secondary Battery

The cycle characteristics of the lithium-ion secondary battery were evaluated in the same manner as in Example 1. The results are shown in Table 1.

### Example 9

An electrode material and an electrode for a lithium-ion secondary battery of Example 9 were produced in the same manner as in Example 8 except for the fact that a mixture obtained by mixing the first electrode active material and the second electrode active material so that the mass ratio between the first electrode active material and the second electrode active material reached 20% and 80% was used as the electrode material.

In addition, the obtained electrode was evaluated in the same manner as in Example 8. The results are shown in Table 1.

Furthermore, the lithium-ion secondary battery of Example 9 was produced in the same manner as in Example 8 using the obtained electrode.

The obtained lithium-ion secondary battery was evaluated in the same manner as in Example 8. The results are shown in Table 1.

### Example 10

An electrode material and an electrode for a lithium-ion secondary battery of Example 10 were produced in the same manner as in Example 8 except for the fact that a mixture obtained by mixing the first electrode active material and the second electrode active material so that the mass ratio between the first electrode active material and the second electrode active material reached 30% and 70% was used as the electrode material.

In addition, the obtained electrode was evaluated in the same manner as in Example 8. The results are shown in Table 1.

Furthermore, the lithium-ion secondary battery of Example 10 was produced in the same manner as in Example 8 using the obtained electrode.

The obtained lithium-ion secondary battery was evaluated in the same manner as in Example 8. The results are shown in Table 1.

### Example 11

An electrode material and an electrode for a lithium-ion secondary battery of Example 11 were produced in the same manner as in Example 8 except for the fact that a mixture obtained by mixing the first electrode active material and the second electrode active material so that the mass ratio between the first electrode active material and the second electrode active material reached 40% and 60% was used as the electrode material.

In addition, the obtained electrode was evaluated in the same manner as in Example 8. The results are shown in Table 1.

Furthermore, the lithium-ion secondary battery of Example 11 was produced in the same manner as in Example 8 using the obtained electrode.

The obtained lithium-ion secondary battery was evaluated in the same manner as in Example 8. The results are shown in Table 1.

### Example 12

An electrode material and an electrode for a lithium-ion secondary battery of Example 12 were produced in the same manner as in Example 8 except for the fact that a mixture obtained by mixing the first electrode active material and the second electrode active material so that the mass ratio between the first electrode active material and the second electrode active material reached 50% and 50% was used as the electrode material.

In addition, the obtained electrode was evaluated in the same manner as in Example 8. The results are shown in Table 1.

Furthermore, the lithium-ion secondary battery of Example 12 was produced in the same manner as in Example 8 using the obtained electrode.

The obtained lithium-ion secondary battery was evaluated in the same manner as in Example 8. The results are shown in Table 1.

### Example 13

An electrode material and an electrode for a lithium-ion secondary battery of Example 13 were produced in the same manner as in Example 8 except for the fact that lithium manganate (LiMn₂O₄) having an average secondary particle diameter of 157 μm was used as the second electrode active material and a mixture obtained by mixing the first electrode active material and the second electrode active material so that the mass ratio between the first electrode active material and the second electrode active material reached 50% and 50% was used as the electrode material.

In addition, the obtained electrode was evaluated in the same manner as in Example 8. The results are shown in Table 1.

Furthermore, the lithium-ion secondary battery of Example 13 was produced in the same manner as in Example 8 using the obtained electrode.

The obtained lithium-ion secondary battery was evaluated in the same manner as in Example 8. The results are shown in Table 1.

### Example 14

An electrode material and an electrode for a lithium-ion secondary battery of Example 14 were produced in the same manner as in Example 8 except for the fact that lithium nickel cobalt aluminum oxide (LiNi_{0.8}Co_{0.15}Al_{0.05}O₂) having an average secondary particle diameter of 56 μm was used as the second electrode active material and a mixture obtained by mixing the first electrode active material and the second electrode active material so that the mass ratio between the first electrode active material and the second electrode active material reached 50% and 50% was used as the electrode material.

In addition, the obtained electrode was evaluated in the same manner as in Example 8. The results are shown in Table 1.

Furthermore, the lithium-ion secondary battery of Example 14 was produced in the same manner as in Example 8 using the obtained electrode.

The obtained lithium-ion secondary battery was evaluated in the same manner as in Example 8. The results are shown in Table 1.

### Example 15

Production of Electrode Material

Lithiumhydroxide (LiOH) (6 mol), iron (II) sulfate (FeSO₄) (2 mol), and phosphoric acid (H₃PO₄) (2 mol) were mixed with water (2 L) so that the total amount reached 4 L, thereby preparing a homogeneous slurry-form mixture.

Next, this mixture was stored in a pressure-resistant airtight container having a capacity of 8 L and was hydrothermally synthesized at 150° C. for one hour.

Next, the obtained precipitate was cleaned with water, thereby obtaining a cake-form electrode active material.

Next, a lactose aqueous solution obtained by dissolving the electrode active material (150 g in terms of the solid content) and lactose (6 g) as an organic compound in water (200 g) and zirconia balls (500 g) having a diameter of 0.1 mm as medium particles were injected into a ball mill, the rotation speed of the ball mill and the stirring time were adjusted so that D90/D10 in the particle size distribution of electrode active material particles in the slurry reached 20, and a dispersion treatment was carried out.

Next, the obtained slurry was sprayed in the atmosphere at 180° C. and dried, thereby obtaining a dried substance having an average particle diameter of 44 μm.

Next, the obtained dried substance was calcinated in a nitrogen atmosphere for one hour at 790° C., thereby obtaining a LiFePO₄ agglomerate having an average secondary particle diameter of 44 μm. This agglomerate was used as the first electrode active material.

In addition, as a second electrode active material, lithium nickel cobalt manganese oxide (LiNi_{1/3}Co_{1/3}Mn_{1/3}O₂) having an average secondary particle diameter of 200 μm was used.

A mixture obtained by mixing the first electrode active material and the second electrode active material so that the mass ratios between the first electrode active material and the second electrode active material reached 50%:50% was used as an electrode material.

Production of Electrode

The electrode material, polyvinylidene fluoride (PVdF) as a binder, and acetylene black (AB) as a conductive auxiliary agent were mixed together so that the mass ratio reached 90:5:5, and furthermore, N-methyl-2-pyrrolidinone (NMP) was added as a solvent so as to impart fluidity, thereby preparing a slurry.

Next, this slurry was applied and dried on a 15 μm-thick aluminum (Al) foil.

After that, the aluminum foil was pressurized at a pressure of 600 kgf/cm², thereby producing an electrode for a lithium-ion secondary battery of Example 15.

Evaluation of Electrode

The electrode thermal conductivity of the electrode was computed in the same manner as in Example 1. The thermal diffusivity, constant pressure specific heat, electrode density, and electrode thermal conductivity are shown in Table 1.

Production of Lithium-Ion Secondary Battery

A lithium-ion secondary battery of Example 15 was produced in the same manner as in Example 1 using the electrode for a lithium-ion secondary battery.

Evaluation of Lithium-Ion Secondary Battery

The cycle characteristics of the lithium-ion secondary battery were evaluated in the same manner as in Example 1. The results are shown in Table 1.

### Example 16

An electrode material and an electrode for a lithium-ion secondary battery of Example 16 were produced in the same manner as in Example 15 except for the fact that the average secondary particle diameter of the first electrode active material was set to 35 μm.

In addition, the obtained electrode was evaluated in the same manner as in Example 15. The results are shown in Table 1.

Furthermore, the lithium-ion secondary battery of Example 16 was produced in the same manner as in Example 15 using the obtained electrode.

The obtained lithium-ion secondary battery was evaluated in the same manner as in Example 15. The results are shown in Table 1.

### Example 17

An electrode material and an electrode for a lithium-ion secondary battery of Example 17 were produced in the same manner as in Example 15 except for the fact that the average secondary particle diameter of the first electrode active material was set to 20 μm.

In addition, the obtained electrode was evaluated in the same manner as in Example 15. The results are shown in Table 1.

Furthermore, the lithium-ion secondary battery of Example 17 was produced in the same manner as in Example 15 using the obtained electrode.

The obtained lithium-ion secondary battery was evaluated in the same manner as in Example 15. The results are shown in Table 1.

### Example 18

An electrode material and an electrode for a lithium-ion secondary battery of Example 18 were produced in the same manner as in Example 15 except for the fact that the average secondary particle diameter of the first electrode active material was set to 2.2 μm and the average secondary particle diameter of the second electrode active material was set to 10 μm.

In addition, the obtained electrode was evaluated in the same manner as in Example 15. The results are shown in Table 1.

Furthermore, the lithium-ion secondary battery of Example 18 was produced in the same manner as in Example 15 using the obtained electrode.

The obtained lithium-ion secondary battery was evaluated in the same manner as in Example 15. The results are shown in Table 1.

### Example 19

An electrode material and an electrode for a lithium-ion secondary battery of Example 19 were produced in the same manner as in Example 15 except for the fact that the average secondary particle diameter of the first electrode active material was set to 0.8 μm and the average secondary particle diameter of the second electrode active material was set to 10 μm.

In addition, the obtained electrode was evaluated in the same manner as in Example 15. The results are shown in Table 1.

Furthermore, the lithium-ion secondary battery of Example 19 was produced in the same manner as in Example 15 using the obtained electrode.

The obtained lithium-ion secondary battery was evaluated in the same manner as in Example 15. The results are shown in Table 1.

### Example 20

An electrode material and an electrode for a lithium-ion secondary battery of Example 20 were produced in the same manner as in Example 15 except for the fact that the average secondary particle diameter of the first electrode active material was set to 0.1 μm and the average secondary particle diameter of the second electrode active material was set to 10 μm.

In addition, the obtained electrode was evaluated in the same manner as in Example 15. The results are shown in Table 1.

Furthermore, the lithium-ion secondary battery of Example 20 was produced in the same manner as in Example 15 using the obtained electrode.

The obtained lithium-ion secondary battery was evaluated in the same manner as in Example 15. The results are shown in Table 1.

### Example 21

An electrode material and an electrode for a lithium-ion secondary battery of Example 21 were produced in the same manner as in Example 15 except for the fact that the average secondary particle diameter of the first electrode active material was set to 10 μm and the average secondary particle diameter of the second electrode active material was set to 150 μm.

In addition, the obtained electrode was evaluated in the same manner as in Example 15. The results are shown in Table 1.

Furthermore, the lithium-ion secondary battery of Example 21 was produced in the same manner as in Example 15 using the obtained electrode.

The obtained lithium-ion secondary battery was evaluated in the same manner as in Example 15. The results are shown in Table 1.

### Example 22

An electrode material and an electrode for a lithium-ion secondary battery of Example 22 were produced in the same manner as in Example 15 except for the fact that the average secondary particle diameter of the first electrode active material was set to 8 μm and the average secondary particle diameter of the second electrode active material was set to 50 μm.

In addition, the obtained electrode was evaluated in the same manner as in Example 15. The results are shown in Table 1.

Furthermore, the lithium-ion secondary battery of Example 22 was produced in the same manner as in Example 15 using the obtained electrode.

The obtained lithium-ion secondary battery was evaluated in the same manner as in Example 15. The results are shown in Table 1.

### Comparative Example 1

An electrode material and an electrode for a lithium-ion secondary battery of Comparative Example 1 were produced in the same manner as in Example 1 except for the fact that a mixture obtained by mixing the first electrode active material and the second electrode active material so that the mass ratio of the first electrode active material reached 100% was used as the electrode material.

In addition, the obtained electrode was evaluated in the same manner as in Example 1. The results are shown in Table 1.

Furthermore, the lithium-ion secondary battery of Comparative Example 1 was produced in the same manner as in Example 1 using the obtained electrode.

The obtained lithium-ion secondary battery was evaluated in the same manner as in Example 1. The results are shown in Table 1.

### Comparative Example 2

An electrode material and an electrode for a lithium-ion secondary battery of Comparative Example 2 were produced in the same manner as in Example 1 except for the fact that a mixture obtained by mixing the first electrode active material and the second electrode active material so that the mass ratio of the first electrode active material reached 0% was used as the electrode material.

In addition, the obtained electrode was evaluated in the same manner as in Example 1. The results are shown in Table 1.

Furthermore, the lithium-ion secondary battery of Comparative Example 2 was produced in the same manner as in Example 1 using the obtained electrode.

The obtained lithium-ion secondary battery was evaluated in the same manner as in Example 1. The results are shown in Table 1.

### Comparative Example 3

An electrode material and an electrode for a lithium-ion secondary battery of Comparative Example 3 were produced in the same manner as in Example 1 except for the fact that a mixture obtained by mixing the first electrode active material and the second electrode active material so that the mass ratio between the first electrode active material and the second electrode active material reached 90% and 10% was used as the electrode material.

In addition, the obtained electrode was evaluated in the same manner as in Example 1. The results are shown in Table 1.

Furthermore, the lithium-ion secondary battery of Comparative Example 3 was produced in the same manner as in Example 1 using the obtained electrode.

The obtained lithium-ion secondary battery was evaluated in the same manner as in Example 1. The results are shown in Table 1.

TABLE 1

| | | | Constant | | | |
|---|---|---|---|---|---|---|
| | Electrode | | pressure | | First | |
| | thermal | Thermal | specific | Electrode | electrode | |
| | conductivity | diffusivity | heat | density | active | Second electrode |
| | [W/(m · K)] | [cm²/sec] | [J/(g · K)] | [g/cm³] | material | active material |
| Example 1 | 0.91 | 4.23 × 10⁻³ | 0.794 | 2.71 | LiFePO₄ | LiNi_{1/3}Co_{1/3}Mn_{1/3}O₂ |
| Example 2 | 0.95 | 4.29 × 10⁻³ | 0.799 | 2.77 | LiFePO₄ | LiNi_{1/3}Co_{1/3}Mn_{1/3}O₂ |
| Example 3 | 1.21 | 5.29 × 10⁻³ | 0.803 | 2.85 | LiFePO₄ | LiNi_{1/3}Co_{1/3}Mn_{1/3}O₂ |
| Example 4 | 1.32 | 5.99 × 10⁻³ | 0.807 | 2.73 | LiFePO₄ | LiNi_{1/3}Co_{1/3}Mn_{1/3}O₂ |
| Example 5 | 1.48 | 6.88 × 10⁻³ | 0.812 | 2.65 | LiFePO₄ | LiNi_{1/3}Co_{1/3}Mn_{1/3}O₂ |
| Example 6 | 1.18 | 5.50 × 10⁻³ | 0.822 | 2.61 | LiFePO₄ | LiMn₂0₄ |
| Example 7 | 1.25 | 5.71 × 10⁻³ | 0.797 | 2.75 | LiFePO₄ | LiNi_{0.8}Co_{0.15}Al_{0.05}O₂ |
| Example 8 | 0.98 | 4.59 × 10⁻³ | 0.794 | 2.69 | LiFe_{0.3}Mn_{0.7}PO₄ | LiNi_{1/3}Co_{1/3}Mn_{1/3}O₂ |
| Example 9 | 1.10 | 5.05 × 10⁻³ | 0.798 | 2.73 | LiFe_{0.3}Mn_{0.7}PO₄ | LiNi_{1/3}Co_{1/3}Mn_{1/3}O₂ |
| Example 10 | 1.28 | 5.64 × 10⁻³ | 0.802 | 2.83 | LiFe_{0.3}Mn_{0.7}PO₄ | LiNi_{1/3}Co_{1/3}Mn_{1/3}O₂ |
| Example 11 | 1.34 | 6.13 × 10⁻³ | 0.806 | 2.71 | LiFe_{0.3}Mn_{0.7}PO₄ | LiNi_{1/3}Co_{1/3}Mn_{1/3}O₂ |
| Example 12 | 1.46 | 6.80 × 10⁻³ | 0.811 | 2.65 | LiFe_{0.3}Mn_{0.7}PO₄ | LiNi_{1/3}Co_{1/3}Mn_{1/3}O₂ |
| Example 13 | 1.18 | 5.50 × 10⁻³ | 0.822 | 2.61 | LiFe_{0.3}Mn_{0.7}PO₄ | LiMn₂0₄ |
| Example 14 | 1.25 | 5.71 × 10⁻³ | 0.797 | 2.75 | LiFe_{0.3}Mn_{0.7}PO₄ | LiNi_{0.8}Co_{0.15}Al_{0.05}O₂ |
| Example 15 | 1.56 | 6.65 × 10⁻³ | 0.812 | 2.89 | LiFePO₄ | LiNi_{1/3}Co_{1/3}Mn_{1/3}O₂ |
| Example 16 | 1.51 | 6.53 × 10⁻³ | 0.812 | 2.85 | LiFePO₄ | LiNi_{1/3}Co_{1/3}Mn_{1/3}O₂ |
| Example 17 | 1.47 | 6.45 × 10⁻³ | 0.812 | 2.81 | LiFePO₄ | LiNi_{1/3}Co_{1/3}Mn_{1/3}O₂ |
| Example 18 | 1.42 | 6.23 × 10⁻³ | 0.812 | 2.81 | LiFePO₄ | LiNi_{1/3}Co_{1/3}Mn_{1/3}O₂ |
| Example 19 | 1.38 | 6.10 × 10⁻³ | 0.812 | 2.79 | LiFePO₄ | LiNi_{1/3}Co_{1/3}Mn_{1/3}O₂ |
| Example 20 | 1.33 | 5.87 × 10⁻³ | 0.812 | 2.79 | LiFePO₄ | LiNi_{1/3}Co_{1/3}Mn_{1/3}O₂ |
| Example 21 | 1.34 | 5.88 × 10⁻³ | 0.812 | 2.81 | LiFePO₄ | LiNi_{1/3}Co_{1/3}Mn_{1/3}O₂ |
| Example 22 | 1.31 | 5.81 × 10⁻³ | 0.812 | 2.78 | LiFePO₄ | LiNi_{1/3}Co_{1/3}Mn_{1/3}O₂ |
| Comparative | 0.47 | 2.49 × 10⁻³ | 0.833 | 2.26 | LiFePO₄ | — |
| Example 1 | | | | | | |
| Comparative | 0.85 | 3.99 × 10⁻³ | 0.790 | 2.70 | — | LiNi_{1/3}Co_{1/3}Mn_{1/3}O₂ |
| Example 2 | | | | | | |
| Comparative | 0.68 | 3.55 × 10⁻³ | 0.829 | 2.31 | LiFePO₄ | LiNi_{1/3}Co_{1/3}Mn_{1/3}O₂ |
| Example 3 | | | | | | |

| | Mass ratio (first | Average secondary | Average secondary | Capacity |
|---|---|---|---|---|
| | electrode active | particle diameter | particle diameter | retention |
| | material/second | of first electrode | of second | after 500 |
| | electrode active | active material | electrode active | cycles at |
| | material) [%] | [μm] | material (M) [μm] | 45° C. [%] |
| Example 1 | 10 | 25 | 100 | 74 |
| Example 2 | 20 | 25 | 100 | 76 |
| Example 3 | 30 | 25 | 100 | 84 |
| Example 4 | 40 | 25 | 100 | 87 |
| Example 5 | 50 | 25 | 100 | 92 |
| Example 6 | 50 | 25 | 157 | 83 |
| Example 7 | 50 | 25 | 56 | 85 |
| Example 8 | 10 | 5 | 100 | 76 |
| Example 9 | 20 | 5 | 100 | 80 |
| Example 10 | 30 | 5 | 100 | 86 |
| Example 11 | 40 | 5 | 100 | 88 |
| Example 12 | 50 | 5 | 100 | 91 |
| Example 13 | 50 | 5 | 157 | 83 |
| Example 14 | 50 | 5 | 56 | 85 |
| Example 15 | 50 | 44 | 200 | 94 |
| Example 16 | 50 | 35 | 200 | 93 |
| Example 17 | 50 | 20 | 200 | 92 |
| Example 18 | 50 | 2.2 | 10 | 90 |
| Example 19 | 50 | 0.8 | 10 | 89 |
| Example 20 | 50 | 0.1 | 10 | 87 |
| Example 21 | 50 | 10 | 150 | 88 |
| Example 22 | 50 | 8 | 50 | 87 |
| Comparative | 100 | 25 | — | 61 |
| Example 1 | | | | |
| Comparative | 0 | — | 100 | 72 |
| Example 2 | | | | |
| Comparative | 90 | 25 | 100 | 67 |
| Example 3 | | | | |

From the results in Table 1, it was found that the electrodes of Example 1 to Example 22 enabled the obtainment of electrodes capable of rapidly solving the local increase in the temperature of electrodes for a lithium-ion secondary battery having an electrode thermal conductivity of 0.9 W/(m·K) or more and an electrode density of 2.0 g/cm³ or more.

On the other hand, it was found that the electrodes of Comparative Example 1 to Comparative Example 3 did not enable the obtainment of electrodes capable of rapidly solving the local increase in the temperature of electrodes for a lithium-ion secondary battery having an electrode thermal conductivity of 0.85 W/(m·K) or less and an electrode density of 2.0 g/cm³ or more.

The electrode for a lithium-ion secondary battery of the present invention has a thermal conductivity, which is derived from Expression (1) using the thermal diffusivity, constant pressure specific heat, and electrode density of the electrode for a lithium-ion secondary battery, of 0.9 W/(m·K) or more, and thus lithium-ion secondary batteries including the electrode for a lithium-ion secondary battery are capable of rapidly solving the local increase in the temperature of electrodes for a lithium-ion secondary battery having an electrode density of 2.0 g/cm³ or more and enable high-speed charging and discharging, and, in the case of next-generation secondary batteries, the effects are extremely significant.

1. An electrode for a lithium-ion secondary battery comprising:
an electrode mixture layer made of a mixture, the mixture comprising:
a first electrode active material including a compound represented by General Formula LiₐA_{b}PO₄, wherein A represents at least one element selected from the group consisting of Fe, Mn, Co, and Ni, 0≤a≤1.0, and 0<b≤1.0;
a second electrode active material including at least one compound selected from the group consisting of compounds represented by General Formula Li_{c}B_{d}O₂, wherein B represents at least one element selected from the group consisting of Fe, Mn, Co, and Ni, 0≤c≤1.0, and 0<c≤1.0, a lithium cobaltate-based compound, a lithium manganate-based compound, and a lithium nickelate-based compound;
a conductive auxiliary agent; and
a binder,
wherein a thermal conductivity of the electrode for the lithium-ion secondary battery, which is derived from Expression (1) using a thermal diffusivity, a constant pressure specific heat, and an electrode density of the electrode for the lithium-ion secondary battery, is 0.9 W/(m·K) or more,
λ=α×Cp×ρ×100 (1)
wherein in the Expression (1), λ is the thermal conductivity [W/(m·K)], α is the thermal diffusivity [cm²/sec], Cp is the constant pressure specific heat [F(g·K)], and ρ is the electrode density [g/cm³].

2. The electrode for the lithium-ion secondary battery according to claim 1,
wherein the first electrode active material further includes a compound represented by General Formula LiₑC_{f}PO₄, wherein C represents at least one element selected from the group consisting of Fe and Mn, 0≤e<2, and 0<f<1.5,
wherein the compound represented by General Formula LiₑC_{f}PO₄ is present on the surface of the compound represented by General Formula LiₐA_{b}PO₄.

3. The electrode for the lithium-ion secondary battery according to claim 1,
wherein an average particle diameter of secondary particles of the first electrode active material is 0.01 M to 0.30 M with respect to an average particle diameter (M) of secondary particles of the second electrode active material, and
wherein the average particle diameter (M) of the secondary particles of the second electrode active material is 10 μm to 200 μm.

4. The electrode for the lithium-ion secondary battery according to claim 1,
wherein the first electrode active material further includes a carbon coating,
wherein at least a surface of the compound represented by General Formula LiₐA_{b}PO₄ is coated with the carbon coating, and
a density of the electrode mixture layer is 2.0 g/cm³ or more.

5. A lithium-ion secondary battery comprising:
the electrode for the lithium-ion secondary battery according to claim 1.
